(19) United States
(12) Patent Application Publication
(10) Pub. No.: US 2008/0207252 A1
(43) Pub. Date: Aug. 28, 2008

(54) MOBILE TELEPHONE WITH DIRECT MEMORY ACCESS

(76) Inventor: Magnus Tillgren, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/678,078

(22) Filed: Feb. 23, 2007

(51) Int. Cl. H04M 1/00

(52) U.S. Cl. 455/550.1

(57) ABSTRACT

A mobile telephone includes call circuitry to establish a call over a communications network and a processing device that executes logical instructions. The mobile telephone also includes a memory assembly. The memory assembly includes a nonvolatile memory, a volatile memory and a logic circuit. The logic circuit has a direct memory access circuit block that independently copies data stored by the nonvolatile memory to the volatile memory in response to a call from the processing device.

### TECHNICAL FIELD OF THE INVENTION

The technology of the present disclosure relates generally to electronic devices and, more particularly, to a mobile telephone with direct memory access between a nonvolatile memory and a volatile memory that are combined in single circuit unit.

### DESCRIPTION OF THE RELATED ART

Mobile and/or wireless electronic devices are becoming increasingly popular. For example, mobile telephones, portable media players and portable gaming devices are now in wide-spread use. In addition, the features associated with certain types of electronic devices have become increasingly diverse. To name a few examples, many electronic devices have cameras, text messaging capability, Internet browsing capability, electronic mail capability, video playback capability, audio playback capability, image display capability and handsfree headset interfaces.

Most mobile telephones have a central processor for carrying out various tasks and executing software that implements the various features of the mobile telephone. The processor also manages memory components of the mobile telephone. For instance, when data is to be copied from a nonvolatile memory (e.g., a flash memory) to a volatile memory (e.g., system random access memory (RAM)), the processor reads the data from the nonvolatile memory and then writes the data to the volatile memory. This process takes time, loads the processor, and loads a data bus used to exchange data between the memories and the processor. Thus, the copying of data from one memory to another slows the overall performance of the mobile telephone.

### SUMMARY

To improve operational performance of a mobile telephone or other electronic devices, there is a need in the art for a system where data may be copied directly from nonvolatile memory to volatile memory with minimal involvement of a processor and with reduced reliance on a data bus over which data may be exchanged between the processor and the memories.

According to one aspect of the invention, a mobile telephone includes call circuitry to establish a call over a communications network; a processing device that executes logical instructions; and a memory assembly. The memory assembly includes a nonvolatile memory; a volatile memory; and a logic circuit having a direct memory access circuit block that independently copies data stored by the nonvolatile memory to the volatile memory in response to a call from the processing device.

According to one embodiment of the mobile telephone, the data is copied over a bus that forms part of the memory assembly.

According to one embodiment of the mobile telephone, the direct memory access circuit block, the nonvolatile memory and the volatile memory of the memory assembly are formed from a single integrated circuit.

According to one embodiment of the mobile telephone, the direct memory access circuit block, the nonvolatile memory and the volatile memory of the memory assembly are embodied as a multi-chip package.

According to one embodiment, the mobile telephone further includes a data bus over which data is exchanged between the processing device and the memory assembly.

According to one embodiment of the mobile telephone, the nonvolatile memory is a flash memory.

According to one embodiment of the mobile telephone, the flash memory has a NAND architecture.

According to one embodiment of the mobile telephone, the volatile memory is random access memory that serves as system memory for the processing device.

According to one embodiment of the mobile telephone, the random access memory is synchronous dynamic random access memory.

According to one embodiment of the mobile telephone, the copying carried out by the direct memory access circuit block is page on demand copying.

According to another aspect of the invention, a memory assembly for a portable electronic device includes a nonvolatile memory; a volatile memory; and a logic circuit having a direct memory access circuit block that independently copies data stored by the nonvolatile memory to the volatile memory in response to a call received by the memory assembly.

According to one embodiment of the memory assembly, the direct memory access circuit block, the nonvolatile memory and the volatile memory of the memory assembly are embodied as a multi-chip package.

According to one embodiment of the memory assembly, the nonvolatile memory is a flash memory and the volatile memory is random access memory that serves as system memory for the portable electronic device.

According to one embodiment of the memory assembly, the copying carried out by the direct memory access circuit block is page on demand copying.

According to another aspect of the invention, a method of managing data in a memory assembly of a portable electronic device where the memory assembly has a nonvolatile memory, a volatile memory and a logic circuit having a direct memory access circuit block includes storing the data with the nonvolatile memory; receiving a call with the memory assembly to initiate copying of the data from the nonvolatile memory to the volatile memory; and copying the data from the nonvolatile memory to the volatile memory under the control of the direct memory access circuit block.

According to one embodiment of the method, the direct memory access circuit block, the nonvolatile memory and the volatile memory of the memory assembly are embodied as a multi-chip package.

According to one embodiment of the method, the nonvolatile memory is a flash memory and the volatile memory is random access memory that serves as system memory for the portable electronic device.

According to one embodiment of the method, the copying carried out by the direct memory access circuit block is page on demand copying.

According to one embodiment of the method, the portable electronic device is a mobile telephone.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic view of a mobile telephone as an exemplary electronic device in accordance with an embodiment of the present invention;

FIG. 2 is a schematic block diagram of the relevant portions of the mobile telephone of FIG. 1; and

FIG. 3 is a schematic diagram of a communications system in which the mobile telephone of FIG. 1 may operate.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

The interchangeable terms “electronic equipment” and “electronic device” include portable radio communication equipment. The term “portable radio communication equipment,” which hereinafter is referred to as a “mobile radio terminal,” includes all equipment such as mobile telephones, pagers, communicators, electronic organizers, personal digital assistants (PDAs), smartphones, portable communication apparatus or the like.

In the present application, embodiments of the invention are described primarily in the context of a mobile telephone. However, it will be appreciated that the invention is not intended to be limited to the context of a mobile telephone and may relate to any type of appropriate electronic equipment, examples of which include a media player, a gaming device and a computer.

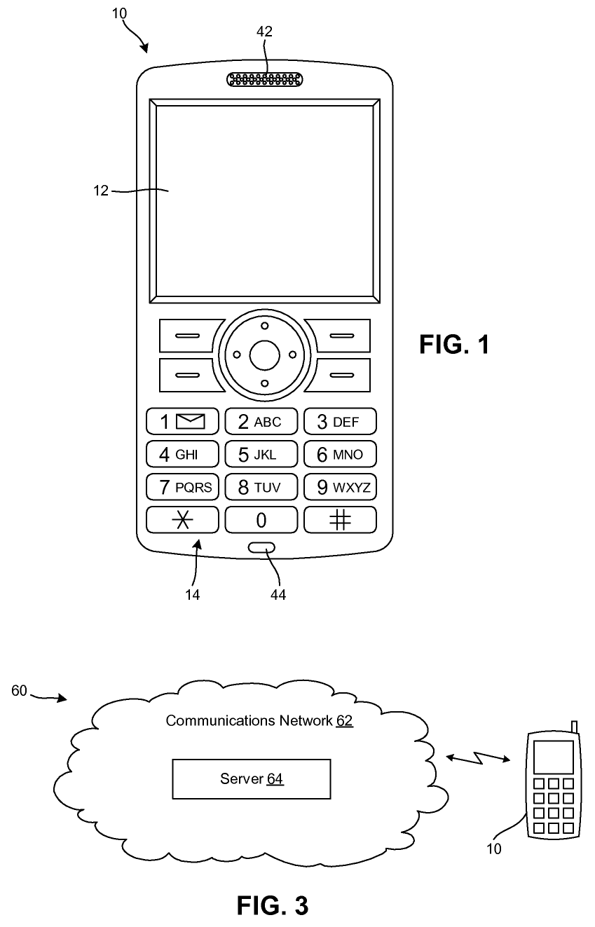

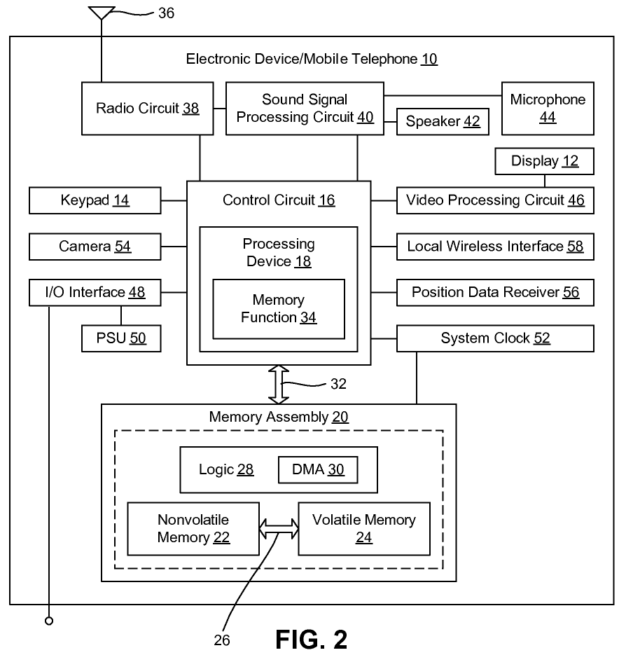

Referring initially to FIGS. 1 and 2, an electronic device 10 is shown. The electronic device of the illustrated embodiment is a mobile telephone and will be referred to as the mobile telephone 10. The mobile telephone 10 is shown as having a “brick” or “block” form factor housing, but it will be appreciated that other housing types may be utilized, such as a “flip-open” form factor (e.g., a “clamshell” housing) or a slide-type form factor (e.g., a “slider” housing).

The mobile telephone 10 may include a display 12. The display 12 displays information to a user such as operating state, time, telephone numbers, contact information, various navigational menus, etc., which enable the user to utilize the various features of the mobile telephone 10. The display 12 also may be used to visually display content received by the mobile telephone 10 and/or retrieved from a memory of the mobile telephone 10. A memory assembly for the mobile telephone 10 will be described in greater detail below. The display 12 may be used to present images, video and other graphics to the user, such as photographs, mobile television content and video associated with games.

A keypad 14 provides for a variety of user input operations. For example, the keypad 14 typically includes alphanumeric keys for allowing entry of alphanumeric information such as telephone numbers, phone lists, contact information, notes, etc. In addition, the keypad 14 typically includes special function keys such as a “call send” key for initiating or answering a call, and a “call end” key for ending or “hanging up” a call. Special function keys also may include menu navigation and select keys to facilitate navigating through a menu displayed on the display 12. For instance, a pointing device and/or navigation keys may be present to accept directional inputs from a user. Special function keys may include audiovisual content playback keys to start, stop and pause playback, skip or repeat tracks, and so forth. Other keys associated with the mobile telephone may include a volume key, an audio mute key, an on/off power key, a web browser launch key, a camera key, etc. Keys or key-like functionality also may be embodied as a touch screen associated with the display 12. Also, the display 12 and keypad 14 may be used in conjunction with one another to implement soft key functionality.

The mobile telephone 10 includes call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VOIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc. Another example includes a video enabled call that is established over a cellular or alternative network.

The mobile telephone 10 may be configured to transmit, receive and/or process data, such as text messages, instant messages, electronic mail messages, multimedia messages, image files, video files, audio files, ring tones, streaming audio, streaming video, data feeds (including podcasts and really simple syndication (RSS) data feeds) and so forth. It is noted that a text message is commonly referred to by some as “an SMS,” which stands for simple message service. SMS is a typical standard for exchanging text messages. Similarly, a multimedia message is commonly referred to by some as “an MMS,” which stands for multimedia message service. MMS is a typical standard for exchanging text messages. Processing such data may include storing the data in memory, executing applications to allow user interaction with the data, displaying video and/or image content associated with the data, outputting audio sounds associated with the data and so forth.

FIG. 2 represents a functional block diagram of the mobile telephone 10. For the sake of brevity, generally conventional features of the mobile telephone 10 will not be described in great detail herein. The mobile telephone 10 includes a primary control circuit 16 that is configured to carry out overall control of the functions and operations of the mobile telephone 10. The control circuit 16 may include a processing device 18, such as a central processing unit (CPU), microcontroller or microprocessor. Among other tasks, the control circuit 20 may carry out timing functions, such as timing the durations of calls, generating the content of time and date stamps, and so forth. The processing device 18 may execute code stored by a memory assembly 20.

In the illustrated embodiment, the memory assembly 20 includes a nonvolatile memory 22 and a system memory that is implemented with a volatile memory 24. As will be appreciated, nonvolatile memory tends not to lose data storage capability upon loss of power and is typically used to store data, application code, files and so forth. The nonvolatile memory 22 may be implemented with a flash memory, for example. The flash memory may have a NAND architecture, but other flash memory architectures, such as a NOR architecture, may be used. As will be appreciated, volatile memory tends to lose data storage capability upon loss of power and is typically used to store data for access by the processing device 18 during the execution of logical routines. The volatile memory 24 may be a random access memory (RAM). The RAM may be a synchronous dynamic random access memory (SDRAM), but other RAM architectures, such as a DRAM, may be used. Data may be exchanged between the nonvolatile memory 22 and the volatile memory 24 over a bus 26 of any appropriate size. The sizes of the nonvolatile memory 22 and the volatile memory 24 may be sized as is appropriate for the mobile telephone 10 or other electronic device in which the memory assembly 20 is used. In addition, the memory assembly 20 may include any appropriate control lines and/or an address bus.

The memory assembly 20 may further include a logic circuit 28 that governs operation of the memory assembly 20. The logic circuit 28 may include a direct memory access (DMA) circuit block 30. The DMA circuit block 30 and/or other portions of the logic circuit 28 may contain circuitry to carryout various logical operations and, if needed, data buffers and any other circuit components to support the logical operations. Operation of the DMA circuit block 30 will be described in greater detail below. The logic circuit 28, the nonvolatile memory 22 and the volatile memory 24 may form a single circuit (indicated by the dashed line in FIG. 2) that has respective circuit sectors. In this embodiment, the logic circuit 28 (inclusive of the DMA circuit block 38), the nonvolatile memory 22 and the volatile memory 24 may be formed as part of same integrated circuit chip. In another embodiment, one or more of the logic circuit 26, the nonvolatile memory 22 or the volatile memory 24 may be implemented on a separate integrated circuit chip from a chip that embodies the other component(s) and these chips may be interfaced together to form the memory assembly 20. In either of these exemplary embodiments, the memory assembly 20 may be considered a multi-chip package (MCP) connoting that multiple functional elements are combined in a single package or chip (even if one chip is used for some or all of the components of the memory assembly 20).

The control circuit 16 and, more particularly, the processing device 18 may be interfaced to the memory assembly 20 over a data bus 32. The data bus 32 may have any appropriate size. For the mobile telephone 10 environment, the data bus 32 may be about sixteen bits wide. Data that is read from the memory assembly 20 by the processing device 18 may be read over the data bus 32. Similarly, data that is written to the memory assembly 20 by the processing device 18 may be written over the data bus 32. The data bus 32 also may be used to exchange control signals between the processing device 18 and the memory assembly 20, or separate control lines may be used for the exchange of control signals. Also, an address bus (not shown) between the processing device 18 and the memory assembly 20 may be present.

As will be appreciated, supplemental non-volatile memory devices may be included with the mobile telephone 10. For instance, the mobile telephone 10 may include one or more of a removable memory (e.g., a flash memory card, a subscriber identity module (SIM) card, and so forth), a hard drive, a removable magnetic disk, an optical disk, and so forth. Also, the mobile telephone 10 may include other memory devices, such as additional RAM, one or more buffers, or other suitable devices. If appropriate, readers and/or drives may be include to read and/or write to the various memory devices. In yet another embodiment, the non-volatile memory 22 may be a removable memory component.

The processing device 18 may execute code that implements various processes and functions of the mobile telephone 10. The code may be stored by the memory assembly 20 in the form of software applications. The code may include a memory function 34, which will be described in greater detail below. It will be apparent to a person having ordinary skill in the art of computer programming, and specifically in application programming for mobile telephones or other electronic devices, how to program a mobile telephone 10 to operate and carry out logical functions associated with the memory function 34. Accordingly, details as to specific programming code have been left out for the sake of brevity. Also, while the memory function 34 is executed by the processing device 18 in accordance with one embodiment of the invention, such functionality could also be carried out via dedicated hardware, firmware, software, or combinations thereof that form part of the control circuit 16, without departing from the scope of the invention. In one embodiment, the memory function 34 may be implemented with executable code or a program stored on a computer or machine readable medium. The memory function 34 may be a stand-alone software application or form a part of a software application that carries out additional tasks related to the mobile telephone 10.

Continuing to refer to FIGS. 1 and 2, the mobile telephone 10 includes an antenna 36 coupled to a radio circuit 38. The radio circuit 38 includes a radio frequency transmitter and receiver for transmitting and receiving signals via the antenna 36 as is conventional. The radio circuit 38 may be configured to operate in a mobile communications system and may be used to send and receive data and/or audiovisual content. Receiver types for interaction with a mobile radio network and/or broadcasting network include, but are not limited to, GSM, CDMA, WCDMA, GPRS, WiFi, WiMax, DVB-H, ISDB-T, etc., as well as advanced versions of these standards.

The mobile telephone 10 may further include a sound signal processing circuit 40 for processing audio signals transmitted by and received from the radio circuit 38. Coupled to the sound processing circuit 40 are a speaker 42 and a microphone 44 that enable a user to listen and speak via the mobile telephone 10 as is conventional. The radio circuit 38 and the sound processing circuit 40 are each coupled to the control circuit 16 so as to carry out overall operation. Audio data may be passed from the control circuit 16 to the sound signal processing circuit 40 for playback to the user. The audio data may include, for example, audio data from an audio file stored by the memory assembly 20 (or other memory device) and retrieved by the control circuit 16, or received audio data such as in the form of streaming audio data from a mobile radio service. The sound processing circuit 40 may include any appropriate buffers, decoders, amplifiers and so forth.

The display 12 may be coupled to the control circuit 16 by a video processing circuit 46 that converts video data to a video signal used to drive the display 12. The video processing circuit 46 may include any appropriate buffers, decoders, video data processors and so forth. The video data may be generated by the control circuit 16, retrieved from a video file that is stored by the memory assembly 20 (or other memory device), derived from an incoming video data stream that is received by the radio circuit 38 or obtained by any other suitable method.

The mobile telephone 10 may further include one or more I/O interface(s) 48. The IPO interface(s) 48 may be in the form of typical mobile telephone I/O interfaces and may include one or more electrical connectors. As is typical, the I/O interface(s) 48 may be used to couple the mobile telephone 10 to a battery charger to charge a battery of a power supply unit (PSU) 50 within the mobile telephone 10. In addition, or in the alternative, the I/O interface(s) 48 may serve to connect the mobile telephone 10 to a headset assembly (e.g., a personal handsfree (PHF) device) that has a wired interface with the mobile telephone 10. Further, the IO interface(s) 48 may serve to connect the mobile telephone 10 to a personal computer or other device via a data cable for the exchange of data. The mobile telephone 10 may receive operating power via the I/O interface(s) 48 when connected to a vehicle power adapter or an electricity outlet power adapter.

The mobile telephone 10 also may include a system clock 52 for clocking the various components of the mobile telephone 10, such as the control circuit 16 and the memory assembly 20.

The mobile telephone 10 may include a camera 54 for taking digital pictures and/or movies. Image and/or video files corresponding to the pictures and/or movies may be stored by the memory assembly 20 or another memory device.

The mobile telephone 10 also may include a position data receiver 56, such as a global positioning system (GPS) receiver, Galileo satellite system receiver or the like. The position data receiver 56 may be involved in determining the location of the mobile telephone 10.

The mobile telephone 10 also may include a local wireless interface 58, such as an infrared transceiver and/or an RF interface (e.g., a Bluetooth interface), for establishing communication with an accessory, another mobile radio terminal, a computer or another device. For example, the local wireless interface 58 may operatively couple the mobile telephone 10 to a headset assembly (e.g., a PHF device) in an embodiment where the headset assembly has a corresponding wireless interface.

With additional reference to FIG. 3, the mobile telephone 10 may be configured to operate as part of a communications system 60. The system 60 may include a communications network 62 having a server 64 (or servers) for managing calls placed by and destined to the mobile telephone 10, transmitting data to the mobile telephone 10 and carrying out any other support functions. The server 64 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 62 may support the communications activity of multiple mobile telephones 10 and other types of end user devices. As will be appreciated, the server 64 may be configured as a typical computer system used to carry out server functions and may include a processor configured to execute software containing logical instructions that embody the functions of the server 64 and a memory to store such software.

Operation of the memory assembly 20 and interaction of the memory assembly 20 with the control circuit 16 will now be described in greater detail. From time to time, an application executed by the processing device 18 or other operation of the control circuit 16 may prompt the transfer (or copying) of data from the nonvolatile memory 22 to the volatile memory 24. In this situation, the memory function 34 may be called to control the copy operation. The memory function 34, in turn, may send a call (e.g., a command) to the memory assembly 20 to carry out the data copy operation. In one embodiment, the memory function 34 calls the DMA circuit block 30 to initiate and control the data copy process. The call may include identification of specific data blocks to be copied.

As indicated, from a system architecture point of view, the DMA circuit block 30 is added directly to the memory assembly 20 and the memory assembly 20 includes both long-term data storage memory (e.g., a NAND or NOR architecture flash memory functioning as nonvolatile memory) and system memory (e.g., a RAM functioning as volatile memory). Upon receipt of the call to copy data, the DMA circuit block 30 oversees the copying of data from the nonvolatile memory 22 to the volatile memory 24 independently of the control circuit 16 or the processing device 18. The DMA circuit block 30 may function as an embedded DMA engine or driver for effectuating the copy operation. Thus, the data transfer operation of offloaded to the memory assembly 20 and the data copying results in minimal or no loading of the processing device 18 and is performed with minimal or no reliance on the data bus 32. Associated reductions in power consumption also may be realized. The reduction of power consumption in portable electronic devices, such as the mobile telephone 10, may be of considerable benefit to extend battery life between rechargings of the battery.

The DMA circuit block 30 may be configured to effectuate a variety of data copy tasks including, but not limited to, page on demand operations (sometimes referred to as demand paging) and scatter-gather operations. It will be appreciated that the data copy operations that may be carried out by the DMA circuit block 30 may include reading and write operations and any other appropriate operations. Without limiting operation of the DMA circuit block 30, it is contemplated that page on demand copying may be readily implemented and/or optimized with the DMA circuit block 30. Page on demand copying typically involves one or more data copy operations that are all of the size and that are located at static boundaries. For instance, the data transfers each may be made in a specified number of bytes, such as four kilobytes, eight kilobytes, twelve kilobytes, sixteen kilobytes or some other size. It will be appreciated, that the specified number of bytes need not be a multiple of four kilobytes. Data transfers that are made in a specified number of bytes leads to the use of predictable buffer sizes and facilitates the implementation of functional circuit components that make up the DMA circuit block 30.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A mobile telephone, comprising:
call circuitry to establish a call over a communications network;
a processing device that executes logical instructions; and
a memory assembly that includes:
a nonvolatile memory;
a volatile memory; and
a logic circuit having a direct memory access circuit block that independently copies data stored by the nonvolatile memory to the volatile memory in response to a call from the processing device.

2. The mobile telephone of claim 1, wherein the data is copied over a bus that forms part of the memory assembly.

3. The mobile telephone of claim 1, wherein the direct memory access circuit block, the nonvolatile memory and the volatile memory of the memory assembly are formed from a single integrated circuit.

4. The mobile telephone of claim 1, wherein the direct memory access circuit block, the nonvolatile memory and the volatile memory of the memory assembly are embodied as a multi-chip package.

5. The mobile telephone of claim 1, further comprising a data bus over which data is exchanged between the processing device and the memory assembly.

6. The mobile telephone of claim 1, wherein the nonvolatile memory is a flash memory.

7. The mobile telephone of claim 6, wherein the flash memory has a NAND architecture.

8. The mobile telephone of claim 6, wherein the volatile memory is random access memory that serves as system memory for the processing device.

9. The mobile telephone of claim 8, wherein the random access memory is synchronous dynamic random access memory.

10. The mobile telephone of claim 1, wherein the volatile memory is random access memory that serves as system memory for the processing device.

11. The mobile telephone of claim 10, wherein the random access memory is synchronous dynamic random access memory.

12. The mobile telephone of claim 1, wherein the copying carried out by the direct memory access circuit block is page on demand copying.

13. A memory assembly for a portable electronic device, comprising:
a nonvolatile memory;
a volatile memory; and
a logic circuit having a direct memory access circuit block that independently copies data stored by the nonvolatile memory to the volatile memory in response to a call received by the memory assembly.

14. The memory assembly of claim 13, wherein the direct memory access circuit block, the nonvolatile memory and the volatile memory of the memory assembly are embodied as a multi-chip package.

15. The memory assembly of claim 13, wherein the nonvolatile memory is a flash memory and the volatile memory is random access memory that serves as system memory for the portable electronic device.

16. The memory assembly of claim 13, wherein the copying carried out by the direct memory access circuit block is page on demand copying.

17. A method of managing data in a memory assembly of a portable electronic device where the memory assembly has a nonvolatile memory, a volatile memory and a logic circuit having a direct memory access circuit block, comprising:
storing the data with the nonvolatile memory;
receiving a call with the memory assembly to initiate copying of the data from the nonvolatile memory to the volatile memory; and
copying the data from the nonvolatile memory to the volatile memory under the control of the direct memory access circuit block.

18. The method of claim 17, wherein the direct memory access circuit block, the nonvolatile memory and the volatile memory of the memory assembly are embodied as a multi-chip package.

19. The method of claim 17, wherein the nonvolatile memory is a flash memory and the volatile memory is random access memory that serves as system memory for the portable electronic device.

20. The method of claim 17, wherein the copying carried out by the direct memory access circuit block is page on demand copying.

21. The method of claim 17, wherein the portable electronic device is a mobile telephone.
